(19) United States
(12) Patent Application Publication
(10) Pub. No.: US 2026/0046799 A1
(43) Pub. Date: Feb. 12, 2026

(54) TIMING ADJUSTMENT FOR SOFT SATELLITE SWITCH WITH RESYNCHRONIZATION

(71) Applicant: QUALCOMM Incorporated, San Diego, CA (US)

(72) Inventors: Bharat SHRESTHA, San Diego, CA (US); Xiao Feng WANG, San Diego, CA (US); Umesh PHUYAL, San Diego, CA (US)

(21) Appl. No.: 19/261,712

(22) Filed: Jul. 7, 2025

Related U.S. Application Data
(60) Provisional application No. 63/680,500, filed on Aug. 7, 2024.

(51) Int. Cl. H04W 56/00; H04W 8/22; H04W 36/18; H04W 84/06

(52) U.S. Cl. CPC H04W 56/0015; H04W 8/22; H04W 36/18; H04W 84/06

(57) ABSTRACT

Methods, systems, and devices for wireless communication are described. A user equipment (UE) may autonomously adjust communication timings for resynchronization when performing a soft switch between satellite network entities. The UE may transmit a first message indicating a capability of the UE to autonomously adjust a synchronization timing in accordance with a resynchronization operation. Then, the UE may receive a second message based on the first message indicating the capability of the UE. The second message may instruct the UE to autonomously adjust the synchronization timing using a time offset associated with the resynchronization operation. The UE may autonomously adjust the synchronization timing in response to switching from communications with a first network entity to communications with a second network entity. The adjustment may occur prior to reception of a reconfiguration message.

### CROSS REFERENCES

The present Application for Patent claims benefit of U.S. Provisional Ser. No. 63/680,500 by SHRESTHA et al., entitled “TIMING ADJUSTMENT FOR SOFT SATELLITE SWITCH WITH RESYNCHRONIZATION,” filed Aug. 7, 2024, assigned to the assignee hereof, and expressly incorporated by reference in its entirety herein.

### FIELD OF TECHNOLOGY

The following relates to wireless communication, including timing adjustment for soft satellite switch with resynchronization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting a first message indicating a capability of the UE to autonomously adjust a synchronization timing in accordance with a resynchronization operation and receiving, based on the first message indicating the capability of the UE, a second message instructing the UE to autonomously adjust, in response to switching from communications with a first network entity to communications with a second network entity, the synchronization timing using a time offset associated with the resynchronization operation.

A UE for wireless communication is described. The UE may include one or more memories storing processor executable code, and one or more processors coupled with the one or more memories. The one or more processors may individually or collectively be operable to execute the code to cause the UE to transmit a first message indicating a capability of the UE to autonomously adjust a synchronization timing in accordance with a resynchronization operation and receive, based on the first message indicating the capability of the UE, a second message instructing the UE to autonomously adjust, in response to switching from communications with a first network entity to communications with a second network entity, the synchronization timing using a time offset associated with the resynchronization operation.

Another UE for wireless communication is described. The UE may include means for transmitting a first message indicating a capability of the UE to autonomously adjust a synchronization timing in accordance with a resynchronization operation and means for receiving, based on the first message indicating the capability of the UE, a second message instructing the UE to autonomously adjust, in response to switching from communications with a first network entity to communications with a second network entity, the synchronization timing using a time offset associated with the resynchronization operation.

A non-transitory computer-readable medium storing code for wireless communication is described. The code may include instructions executable by one or more processors to transmit a first message indicating a capability of the UE to autonomously adjust a synchronization timing in accordance with a resynchronization operation and receive, based on the first message indicating the capability of the UE, a second message instructing the UE to autonomously adjust, in response to switching from communications with a first network entity to communications with a second network entity, the synchronization timing using a time offset associated with the resynchronization operation.

In some examples of the method, UEs, and non-transitory computer-readable medium described herein, adjusting, in response to switching from communications with the first network entity to communications with the second network entity, the synchronization timing in accordance with the resynchronization operation prior to a reception of a reconfiguration message and receiving the reconfiguration message indicating a configuration for communicating with the second network entity in accordance with the resynchronization operation.

Some examples of the method, UEs, and non-transitory computer-readable medium described herein may further include operations, features, means, or instructions for receiving a third message indicating the time offset associated with the resynchronization operation.

Some examples of the method, UEs, and non-transitory computer-readable medium described herein may further include operations, features, means, or instructions for receiving a fourth message indicating whether the time offset includes a negative value or a positive value.

Some examples of the method, UEs, and non-transitory computer-readable medium described herein may further include operations, features, means, or instructions for receiving a fifth message indicating a range that includes both positive values and negative values, where the time offset includes a value within the range.

Some examples of the method, UEs, and non-transitory computer-readable medium described herein may further include operations, features, means, or instructions for receiving, via a measurement object or a system information block, assistance information indicating a switch time associated with the resynchronization operation, a synchronization signal block (SSB) offset time associated with the resynchronization operation, an identifier associated with the second network entity, or any combination thereof.

Some examples of the method, UEs, and non-transitory computer-readable medium described herein may further include operations, features, means, or instructions for receiving a configuration for reporting a propagation delay difference (PDD) between a set of multiple network entities and transmitting a first PDD between the first network entity and the second network entity, where the resynchronization operation may be based on the first PDD.

In some examples of the method, UEs, and non-transitory computer-readable medium described herein, receiving the configuration for reporting the PDD may include operations, features, means, or instructions for receiving an indication of a threshold associated with a trigger event for reporting the PDD.

Some examples of the method, UEs, and non-transitory computer-readable medium described herein may further include operations, features, means, or instructions for modifying, as part of the resynchronization operation and using the time offset, a measurement gap associated with the synchronization timing and modifying, as part of the resynchronization operation and using the time offset, a measurement timing configuration offset associated with the synchronization timing.

Some examples of the method, UEs, and non-transitory computer-readable medium described herein may further include operations, features, means, or instructions for modifying, as part of the resynchronization operation and using the time offset, an expiry of a round trip time (RTT) timer associated with the synchronization timing.

Some examples of the method, UEs, and non-transitory computer-readable medium described herein may further include operations, features, means, or instructions for modifying, as part of the resynchronization operation and using the time offset, an initialization of a retransmission timer associated with the synchronization timing.

Some examples of the method, UEs, and non-transitory computer-readable medium described herein may further include operations, features, means, or instructions for modifying, as part of the resynchronization operation and using the time offset, a set of resource occasions associated with the synchronization timing.

In some examples of the method, UEs, and non-transitory computer-readable medium described herein, the time offset includes an SSB time offset.

In some examples of the method, UEs, and non-transitory computer-readable medium described herein, the first network entity and the second network entity include non-terrestrial network entities.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports timing adjustment for soft satellite switch with resynchronization in accordance with one or more aspects of the present disclosure.

FIG. 2 shows an example of a wireless communications system that supports timing adjustment for soft satellite switch with resynchronization in accordance with one or more aspects of the present disclosure.

FIG. 3 shows an example of a process flow that supports timing adjustment for soft satellite switch with resynchronization in accordance with one or more aspects of the present disclosure.

FIGS. 4 and 5 show block diagrams of devices that support timing adjustment for soft satellite switch with resynchronization in accordance with one or more aspects of the present disclosure.

FIG. 6 shows a block diagram of a communications manager that supports timing adjustment for soft satellite switch with resynchronization in accordance with one or more aspects of the present disclosure.

FIG. 7 shows a diagram of a system including a device that supports timing adjustment for soft satellite switch with resynchronization in accordance with one or more aspects of the present disclosure.

FIGS. 8 through 11 show flowcharts illustrating methods that support timing adjustment for soft satellite switch with resynchronization in accordance with one or more aspects of the present disclosure.

### DETAILED DESCRIPTION

In some wireless communications systems, a user equipment (UE) may switch from communicating with a first satellite network entity to communicating with a second satellite network entity. Such a switching operation may be an example of a soft switch, where a synchronization signal block (SSB) of a first satellite network entity and an SSB of a second satellite network entity overlap for a duration. During such a switch (e.g., when the UE connects to the second satellite network entity), the UE may follow the SSB of the second satellite network entity. Thus, the UE may shift a downlink timing of the SSB by a time offset. As a result, a preconfigured end point may change for one or more variables associated with synchronization timing. After the switch is complete, the UE may receive a reconfiguration message to correct these timing differences. However, this may result in increased signaling overhead, which may reduce efficiency and may diminish the user experience.

Techniques described herein support a UE to autonomously adjust communication timings for resynchronization when performing a soft switch between network entities (e.g., satellite network entities). The UE may transmit, to a network entity, a first message indicating a capability of the UE to autonomously adjust a synchronization timing in accordance with a resynchronization operation. Then, the UE may receive, from the network entity, a second message based at least in part on the first message indicating the capability of the UE. The second message may instruct the UE to autonomously adjust the synchronization timing using a time offset associated with the resynchronization operation. The UE may autonomously adjust the synchronization timing in response to switching from communications with a first network entity to communications with a second network entity. In some cases, the adjustment may occur prior to reception of a reconfiguration message. For example, the UE may receive a radio resource control (RRC) reconfiguration message for communicating with the second network entity. In some examples, the UE may receive, from the network entity, an indication of the time offset for adjusting the synchronization timing.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to timing adjustment for soft satellite switch with resynchronization.

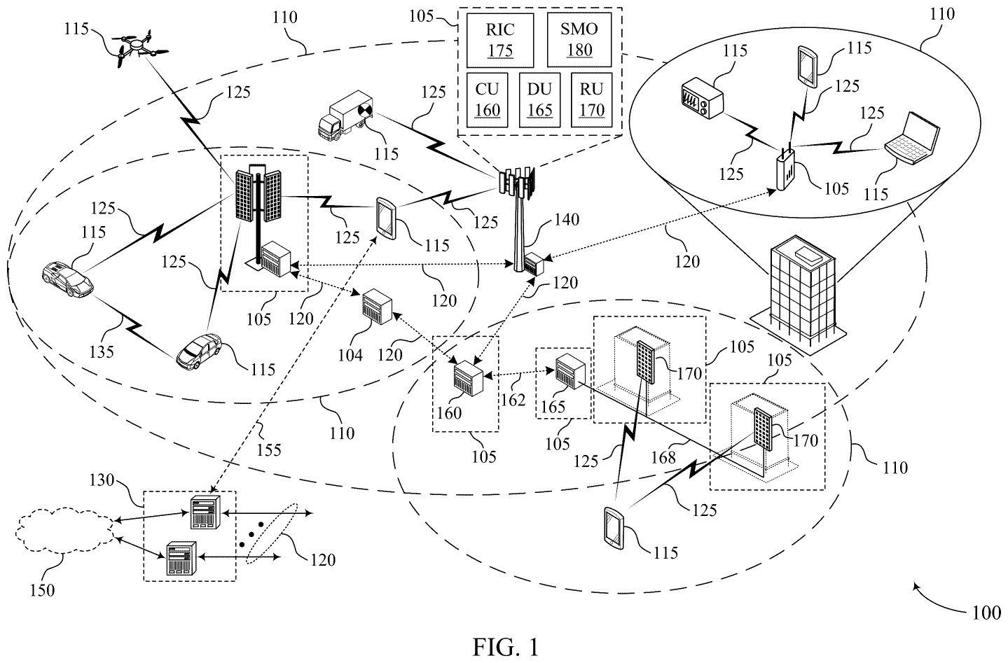

FIG. 1 shows an example of a wireless communications system 100 that supports timing adjustment for soft satellite switch with resynchronization in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a satellite cell (e.g., a network entity cell) may remain fixed at a given coverage area for a duration (e.g., a fixed cell scenario). For example, the satellite cell may provide coverage for one or more UEs within the coverage area for the duration. After the duration, the satellite cell may terminate coverage for the coverage area (e.g., being switched off) and a second (e.g., new) satellite cell may provide coverage for the coverage area. However, if a UE supports satellite switch with resynchronization, the UE may detect a same cell from a different satellite. In some cases, for a relatively short period of time, respective SSBs from a source satellite and a target satellite may overlap (e.g., triggering a soft switch). Alternatively, the UE may end communications with the source satellite and may begin communications with the target satellite (e.g., a hard switch).

A source SSB of the source satellite may be offset from a target SSB of the target satellite (e.g., by a value referred to as ssb-TimeOffset). The target SSB may begin at a first time (e.g., t-ServiceStart). The UE may detect the target SSB and synchronize with the target SSB beginning at the first time for a synchronizing duration. However, the UE may leave the source satellite at a second time (e.g., t-Service) after the first time and the synchronizing duration may end after the second time. After connecting to the target satellite, the UE may follow the target SSB, and thus may shift a downlink timing of the SSB by a time offset (e.g., ssb-TimeOffset).

A downlink transmission may include a particular quantity of subframes (e.g., 24 subframes). In some cases, the UE may initialize (e.g., start) a round trip time (RTT) timer (e.g., an HARQ RTT timer) after a physical uplink shared channel (PUSCH) transmission (e.g., after a PUSCH last repetition). The UE may monitor a physical downlink control channel (PDCCH) starting at a subframe 21 corresponding to the source SSB. The subframe 21 corresponding to the source SSB may overlap with subframe 19 corresponding to the target SSB (e.g., depending on a value of the time offset). At a same time, the UE may stop the RTT timer and may initialize a discontinuous reception (DRX) timer.

Due to changes in downlink timing, a preconfigured end point (e.g., corresponding to the synchronizing duration) may change for one or more parameters. The one or more parameters may include scheduled timers, a downlink assignment, uplink resource transmission occasions, a neighbor cell measurement gap, an SSB measurement timing configuration (SMTC), or any combination thereof. After performing the switch from the source satellite to the target satellite, the UE may receive a configuration (or an update for the configuration) via an RRC reconfiguration message (e.g., from the network entity 105-b). However, such a signal may result in increased signaling overhead.

In some wireless communications systems, if a configured neighbor cell participates in a switching procedure (e.g., soft satellite switch with resynchronization), then after the switch, the UE may fail to receive a measurement associated with the configured neighbor cell. A similar issue may occur for neighbor cell measurements during an idle mode if the neighbor cell participates in the switching procedure.

Techniques described herein may support adjustment of timing until a new configuration is received. For example, the wireless communications system 100 may support a UE 115 to autonomously adjust communication timings for resynchronization when performing a soft switch between network entities (e.g., satellite network entities). The UE 115 may transmit, to a network entity 105, a first message indicating a capability of the UE 115 to autonomously adjust a synchronization timing in accordance with a resynchronization operation. Then, the UE 115 may receive, from the network entity 105, a second message based on the first message indicating the capability of the UE 115. The second message may instruct the UE 115 to autonomously adjust the synchronization timing using a time offset associated with the resynchronization operation. The UE 115 may autonomously adjust the synchronization timing in response to switching from communications with a first network entity 105 to communications with a second network entity 105. In some cases, the adjustment may occur prior to reception of a reconfiguration message. For example, the UE 115 may receive a RRC reconfiguration message for communicating with the second network entity. In some examples, the UE 115 may receive, from the network entity 105, an indication of the time offset for adjusting the synchronization timing.

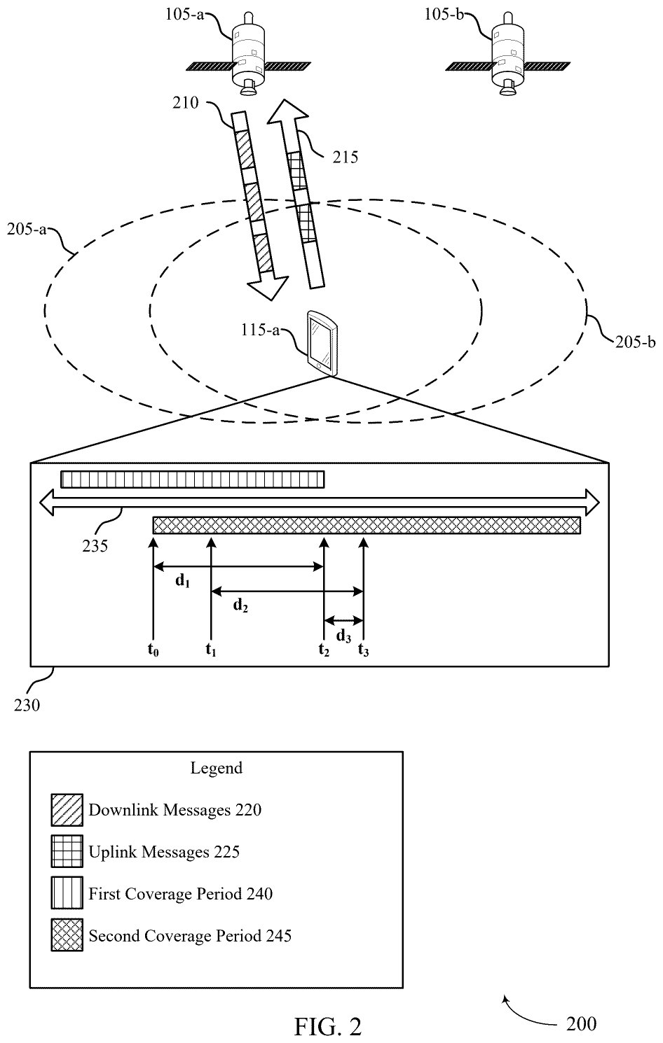

FIG. 2 shows an example of a wireless communications system 200 that supports timing adjustment for soft satellite switch with resynchronization in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a and a network entity 105-b), which may be examples of the corresponding devices as described herein. The network entity 105-a may communicate with one or more UEs 115 in a first coverage area 205-a. Similarly, the network entity 105-b may communicate with one or more UEs 115 in a second coverage area 205-b. In some implementations, (e.g., as illustrated in FIG. 2), the UE 115-a may be located in an overlapping region which is within the first coverage area 205-a and within the second coverage area 205-b.

In some implementations, the UE 115-a may communicate with a network entity 105 (e.g., the network entity 105-a) via one or more wireless links. For example, the UE 115-a may receive signaling via a wireless link 210 and may transmit uplink signaling via a wireless link 215. In some cases, the wireless link 210 and the wireless link 215 may be respective examples of physical channels. The UE 115-a may exchange messages with the network entity 105-a prior to establishing communications with the network entity 105-b. For example, the UE 115-a may receive one or more downlink messages 220 from the network entity 105-a (e.g., via the wireless link 210). Similarly, the UE 115-a may transmit one or more uplink messages to the network entity 105-a (e.g., via the wireless link 215).

In some implementations, the UE 115-a may transmit an uplink message 225 to the network entity 105-a. The uplink message 225 may include capability information that indicates a capability of the UE 115-a to adjust a timing associated with communicating with a network entity 105 (e.g., the network entity 105-a). That is, the uplink message 225 may indicate that the UE 115-a supports adjusting the timing autonomously. In some cases, the UE 115-a may receive, from the network entity 105-a, a downlink message 220 that includes information that instructs the UE 115-a to autonomously adjust the timing associated with communicating with the network entity 105. For example, the downlink message 220 may enable the UE 115-a to perform an adjustment to the timing (and one or more other parameters) in response to a switch from the network entity 105-a to the network entity 105-b. Further, the downlink message 220 may allow the UE to autonomously adjust the timing using a time offset. In some examples, the UE 115-a may receive the downlink message 220 and may refrain from performing the adjustment until the switch occurs. In other words, the downlink message 220 may give permission to the UE 115-a to perform such an autonomous adjustment based on the capability information of the uplink message 225.

The UE 115-a may perform a switching procedure (e.g., a soft switch) to end communications with the network entity 105-a and begin (e.g., establish) communications with the network entity 105-b. The wireless communications system 200 includes an example of a timing diagram 230 that illustrates the switching procedure as it may occur in time. The timing diagram 230 includes a time axis 235, a first coverage period 240, and a second coverage period 245. The first coverage period 240 may represent a first duration where the UE 115-a is in communication with the network entity 105-a. During the first coverage period 240, the UE 115-a may use a source SSB (e.g., an SSB associated with the network entity 105-a) for wireless communications. Similarly, the second coverage period 245 may represent a second duration where the UE 115-a is in communication with the network entity 105-b.

During the second coverage period 245, the UE 115-a may use a target SSB (e.g., an SSB associated with the network entity 105-b) for wireless communications. Thus, the first coverage period 240 and the second coverage period 245 may represent durations where the UE 115-a may use the source SSB and the target SSB, respectively. As shown, the first coverage period 240 may overlap with the second coverage period 245 along the time axis 235. During the overlapping period, the UE 115-a may perform the switching procedure.

The UE 115-a may use a first downlink timing for communicating with the network entity 105-a during the first coverage period 240. Similarly, the UE 115-a may use a second downlink timing (e.g., different from the first downlink timing) for communicating with the network entity 105-b during the second coverage period 245. The second downlink timing may be similar to the first downlink timing. However, the second downlink timing may be offset from the first downlink timing by a time offset (e.g., ssb-TimeOffset). A downlink transmission may include a particular quantity of subframes (e.g., 24 subframes). Thus, a first subframe corresponding to the second downlink timing may occur after a first subframe of the first downlink timing (or before the first subframe of the first downlink timing, for example, if the time offset is negative).

At time t₀ (e.g., t-ServiceStart), the second coverage period 245 may begin. During a duration d₁ (e.g.,-ve t-gap), the first coverage period 240 and the second coverage period 245 may overlap. At time t₁, the UE 115-a may begin synchronizing with network entity 105-b (e.g., aligning with the second downlink timing). The synchronizing may occur during a duration d₂. At time t₂ (e.g., t-Service), the first coverage period 240 may end. Thus, the UE 115-a may communicate with the network entity 105-b and may not communicate with the network entity 105-a starting at time t₂. At time t₃, the UE 115-a may finish synchronizing with the network entity 105-b. In some cases, if time t₃ occurs after time t₂, this may result in a duration d₃ during which the UE 115-a may finish synchronizing, after which the UE 115-a may resume uplink and downlink transmission.

After a cell stop time (e.g., after t₂ or t-Service) and until the UE 115-a receives an RRC reconfiguration message, the UE 115-a may modify or adjust the source SSB and one or more parameters (e.g., associated with the source SSB) to obtain the target SSB and one or more target parameters (e.g., associated with the target SSB). For example, the UE 115-a may shift an expiry of a HARQ RTT timer by a time offset (e.g., ssb-TimeOffset). Alternatively, the UE 115-a may shift a start of a DRX retransmission timer by the time offset. In some cases, the UE 115-a may move one or more configured or scheduled resource occasions (e.g., configured grant occasions) in a time domain by the time offset. In some implementations, the UE 115-a may shift the measurement gap by the time offset. Further, the UE 115-a may shift one or more SMTC offsets of one or more neighbor cells (e.g., the network entity 105-b or another network entity 105) by the time offset. As described herein, an SMTC may refer to an SSB or a physical broadcast channel (PBCH) block measurement timing configuration (e.g., an SS/PBCH block measurement timing configuration).

The UE 115-a may receive, from the network entity 105-a, a downlink message 220 that includes an indication of whether the UE 115-a is to apply a negative or a positive time offset. The indication may be a parameter within a configuration (e.g., offset-SatSwitchWithReSync-r18). The parameter may have a value indicating that the time offset is negative. The parameter may be optional within the configuration. For example, in some cases, the downlink message 220 may indicate that the UE 115-a is to add the time offset to each of the one or more parameters (e.g., SSBtarget=SSBsource+ssb-TimeOffset). In some other cases, the downlink message 220 may indicate that the UE 115-a is to subtract the time offset from each of the one or more parameters (e.g., SSBtarget=SSBsource−ssb-TimeOffset). Alternatively, the network entity 105-a may refrain from broadcasting an indication of the time offset. In such an implementation, a first UE 115 may perform a hard switch (e.g., rather than a soft switch). A second UE 115 may receive a range for the time offset (e.g., an integer in the range of −158 and 159) and may select the time offset from the range.

In some implementations (e.g., to avoid an RRC reconfiguration of system information block update due to an action of a neighbor cell), the UE 115-a may receive, from a network entity 105 (e.g., the network entity 105-a), assistance information (e.g., in a downlink message 220) associated with the switching procedure (e.g., a soft switch with resynchronization). The UE 115-a may receive the assistance information in a measurement object or in a neighbor satellite list (e.g., a list of information associated with network entities 105 within a system information block). In some cases, the assistance information may include a switch time, an SSB offset time, identification information associated with the network entity 105-b, or any combination thereof.

In some examples, the UE 115-a may receive a configuration that includes an information element related to reporting a propagation delay difference (PDD) between a set of network entities 105. The information element may include a configuration for the UE 115-a to report the PDD for the switching procedure. The configuration may include a sequence of parameters. For example, the sequence of parameters may include a threshold associated with reporting the PDD. The threshold may have on a value of a set of values (e.g., ms0dot5, ms1, ms2, ms3, ms4, ms5, ms6, ms7, ms8, ms9, ms10, spare5, spare4, spare3, spare2, spare1, and so on). The threshold parameter may be optional in the configuration.

In some cases, the UE 115-a may receive a 1-bit indication associated with reporting the PDD. In such cases, the UE 115-a may receive associated satellite information in a system information block. Additionally, or alternatively, the UE 115-a may receive an indication the threshold. The threshold may be for a measurement associated with switching between network entities 105. For example, if the threshold is satisfied, the UE 115-a may trigger a PDD report. In some cases, the threshold may be configured to trigger the PDD report at time t₀ (e.g., when the second coverage period 245 begins). That is, the threshold may be associated with detecting, at the UE 115-a, that the network entity 105-b has begun coverage for the UE 115-a. In some cases, the UE 115-a may transmit a PDD report a single time after the switch procedure is complete. A network entity 105 that receives such a PDD report may use the PDD report to update an SMTC and a measurement gap configuration for communications at the UE 115-a.

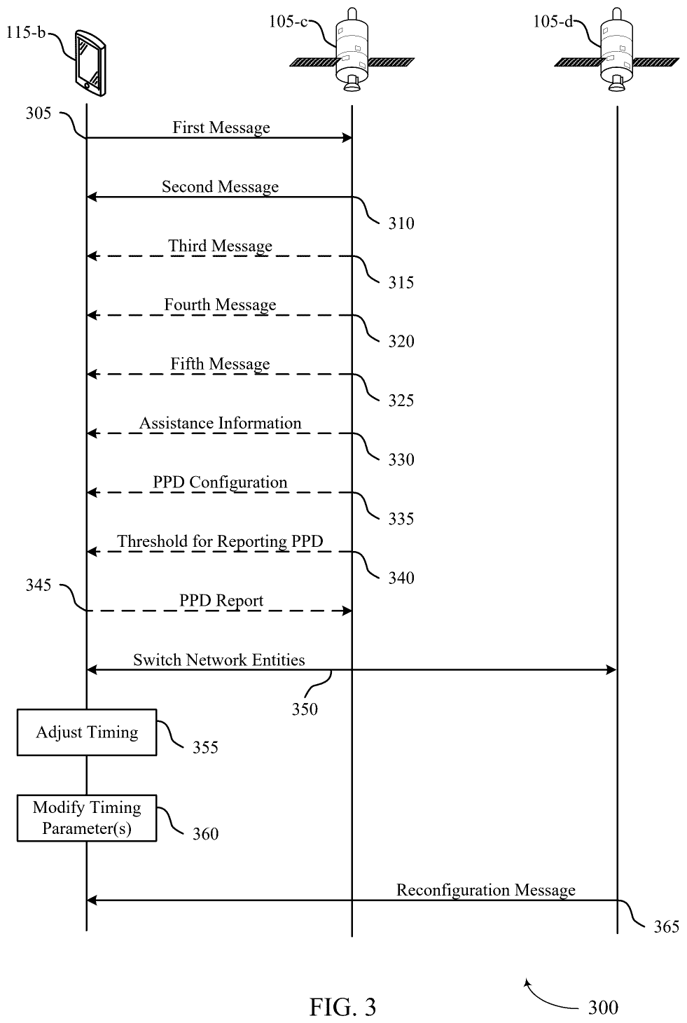

FIG. 3 shows an example of a process flow 300 that supports timing adjustment for soft satellite switch with resynchronization in accordance with one or more aspects of the present disclosure. The process flow 300 includes a UE 115-b, a network entity 105-c, and a network entity 105-d, which may be examples of the corresponding devices as described with respect to FIGS. 1 and 2. In the following description of the process flow 300, the operations between the UE 115-b, the network entity 105-c, and the network entity 105-d may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may transmit a first message to the network entity 105-c. The first message may indicate a capability of the UE 115-b to autonomously adjust a synchronization timing in accordance with a resynchronization operation. As described herein, the network entity 105-c and the network entity 105-d may be respective examples of non-terrestrial network entities (e.g., satellite network entities).

At 310, the UE 115-b may receive, from the network entity 105-c a second message based on the first message indicating the capability of the UE 115-b. The second message may instruct the UE 115-b to autonomously adjust, in response to switching from communications with a first network entity 105 (e.g., the network entity 105-c) to communications with a second network entity 105 (e.g., the network entity 105-d), the synchronization timing using a time offset associated with the resynchronization operation. In some cases, the time offset may be or may include a synchronization signal block time offset (e.g., ssb-TimeOffset). Communications with a particular network entity 105 may refer to a state in which the UE 115-b may be in a coverage area of the particular network entity 105. For example, the UE 115-b may exchange message with the particular network entity 105 while in the coverage area (as described with reference to FIG. 2).

At 315, the UE 115-b may receive a third message indicating the time offset associated with the resynchronization operation. In some cases, the second message (e.g., received at 310) may be indicative of the third message. At 320, the UE 115-b may receive a fourth message indicating whether the time offset is a negative value or a positive value. For example, the fourth message may include or may be a one-bit indication, where a ‘1’ may indicate that the time offset is a negative value and a ‘0’ may indicate that the time offset is a positive value (or vice versa). In some implementations, if the fourth message indicates that the time offset is a positive value, the UE 115-b may adjust one or more values (e.g., the synchronization timing) by adding the time offset to the one or more values. Additionally, or alternatively, if the fourth message indicates that the time offset is a negative value, the UE 115-b may adjust the one more values by subtracting the time offset from the one or more values. In some cases, the third message and the fourth message may be a same message or may be separate messages.

At 325, the UE 115-b may receive a fifth message that indicates a range that includes both positive values and negative values. The time offset may be a value within the range. In some examples, the fifth message may be communicated as part of the third message or as part of the fourth message. The UE 115-b may select the time offset as the value within the range based on a configuration of the UE 115-b or based on one or more messages from the network entity 105-c.

At 330, the UE 115-b may receive assistance information via a measurement object or a system information block. The assistance information may indicate a switch time associated with the resynchronization operation, a synchronization signal block offset time associated with the resynchronization operation, an identifier associated with the second network entity 105 (e.g., the network entity 105-d), or any combination thereof.

At 335, the UE 115-b may receive a configuration for reporting a PDD between multiple network entities. At 340, the UE 115-b may receive an indication of a threshold associated with a trigger event for reporting the propagation delay difference. The threshold may be associated with a switch event at the UE 115-b. For example, if the UE 115-b detects that it is to switch from communications with the network entity 105-c to communications with the network entity 105-d, the threshold may be satisfied, triggering the PDD report. In some cases, the threshold may be associated with a PDD value. For example, if a first PDD between the first network entity 105 (e.g., the network entity 105-c) and the second network entity 105 (e.g., the network entity 105-d) satisfies (e.g., exceeds) the threshold, the UE 115-b may report the first PDD.

At 345, the UE 115-b may transmit the first PDD. In some examples, the UE 115-b may transmit the first PDD based on one or more values (e.g., the first PDD) satisfying the threshold. In some cases, the UE 115-b may transmit the first PDD to the network entity 105-c. Additionally, or alternatively, the UE 115-b may transmit the first PDD to the network entity 105-d. The resynchronization operation may be based on the first PDD. For example, the network entity 105-c (or in some cases, the network entity 105-d) may transmit, to the UE 115-b and based on the first PDD, one or more messages that indicate one or more parameters which the UE 115-b may use for the resynchronization operation. In some examples, the network entity 105-d may participate in the resynchronization operation using the PDD. In some implementations, the UE 115-b may transmit one or more second PDDs associated with one or more other network entities 105.

At 350, the UE 115-b may perform a switch operation to switch from communications with the network entity 105-c to communications with the network entity 105-d. In some cases, the switch operation may be based on the first PPD report (and one or more other PPD reports). Further, the switch operation may be based on one or more messages from the network entity 105-c, the network entity 105-d, or both.

At 355, the UE 115-b may adjust the synchronization timing in response to switching from communications with the first network entity to communications with the second network entity 105 (e.g., the network entity 105-d). The UE 115-b may adjust the synchronization timing in accordance with the resynchronization operation prior to a reception of a reconfiguration message.

At 360, the UE 115-b may modify one or more timing parameters. For example, the UE 115-b may modify, as part of the resynchronization operation and using the time offset, a measurement gap associated with the synchronization timing. Similarly, the UE 115-b may modify, as part of the resynchronization operation and using the time offset, a measurement timing configuration offset associated with the synchronization timing.

In some implementations, the UE 115-b may modify one or more additional timing parameters. For example, the UE 115-b may modify, as part of the resynchronization operation and using the time offset, an expiry of an RTT timer associated with the synchronization timing. Additionally, or alternatively, the UE 115-b may modify, as part of the resynchronization operation and using the time offset, an initialization of a retransmission timer associated with the synchronization timing. In some cases, the UE 115-b may modify, as part of the resynchronization operation and using the time offset, a set of resource occasions associated with the synchronization timing.

At 365, the UE 115-b may receive the reconfiguration message indicating a configuration for communicating with the second network entity 105 (e.g., the network entity 105-d) in accordance with the resynchronization operation. In some cases, the UE 115-b may receive the reconfiguration message from the network entity 105-d. In some examples, the UE 115-b may adjust the synchronization timing, one or more timing parameters, or both, based on the reconfiguration message.

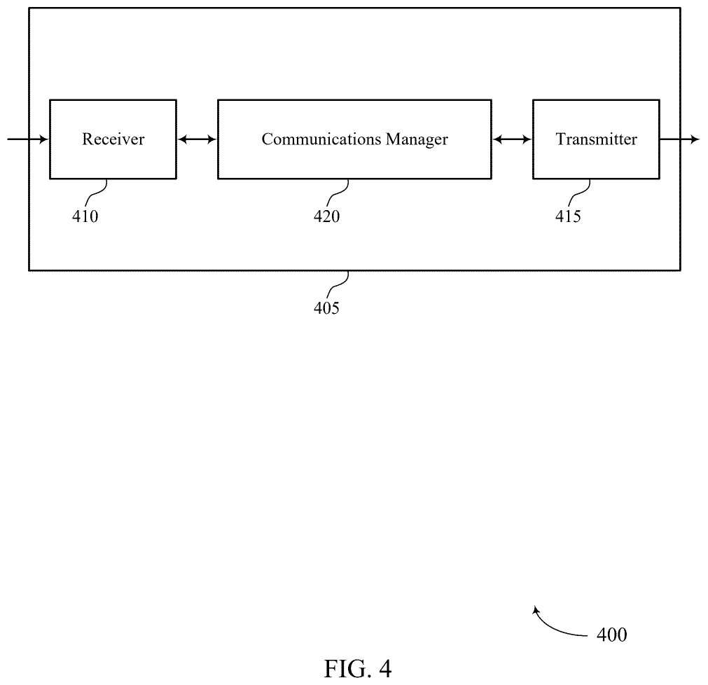

FIG. 4 shows a block diagram 400 of a device 405 that supports timing adjustment for soft satellite switch with resynchronization in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to timing adjustment for soft satellite switch with resynchronization). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to timing adjustment for soft satellite switch with resynchronization). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of timing adjustment for soft satellite switch with resynchronization as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for transmitting a first message indicating a capability of the UE to autonomously adjust a synchronization timing in accordance with a resynchronization operation. The communications manager 420 is capable of, configured to, or operable to support a means for receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for timing adjustment for soft satellite switch with resynchronization, which may result in reduced processing, reduced power consumption, more efficient switching procedures, and more efficient utilization of communication resources, among other advantages.

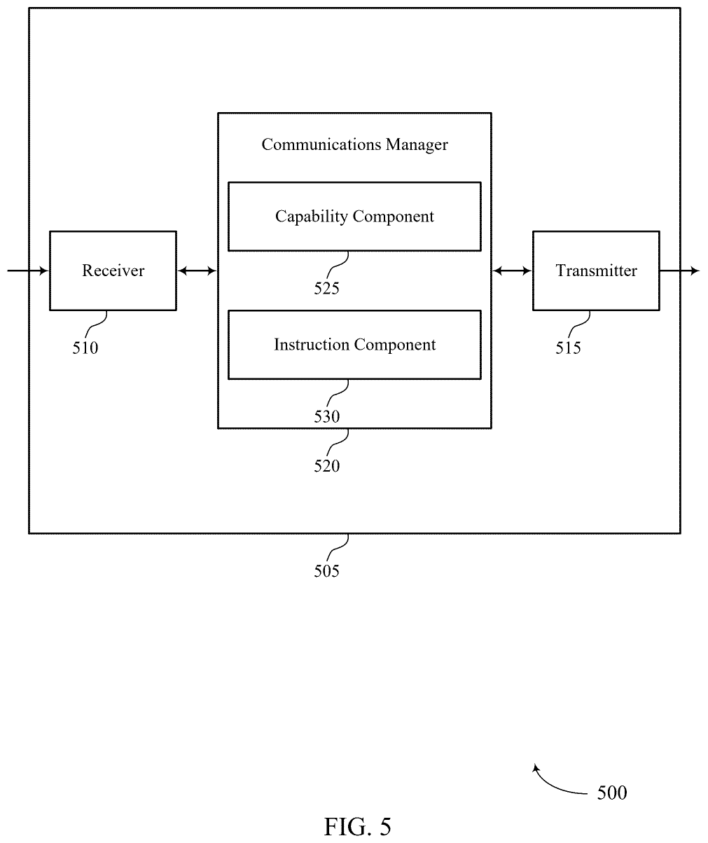

FIG. 5 shows a block diagram 500 of a device 505 that supports timing adjustment for soft satellite switch with resynchronization in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to timing adjustment for soft satellite switch with resynchronization). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to timing adjustment for soft satellite switch with resynchronization). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of timing adjustment for soft satellite switch with resynchronization as described herein. For example, the communications manager 520 may include a capability component 525 an instruction component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The capability component 525 is capable of, configured to, or operable to support a means for transmitting a first message indicating a capability of the UE to autonomously adjust a synchronization timing in accordance with a resynchronization operation. The instruction component 530 is capable of, configured to, or operable to support a means for receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

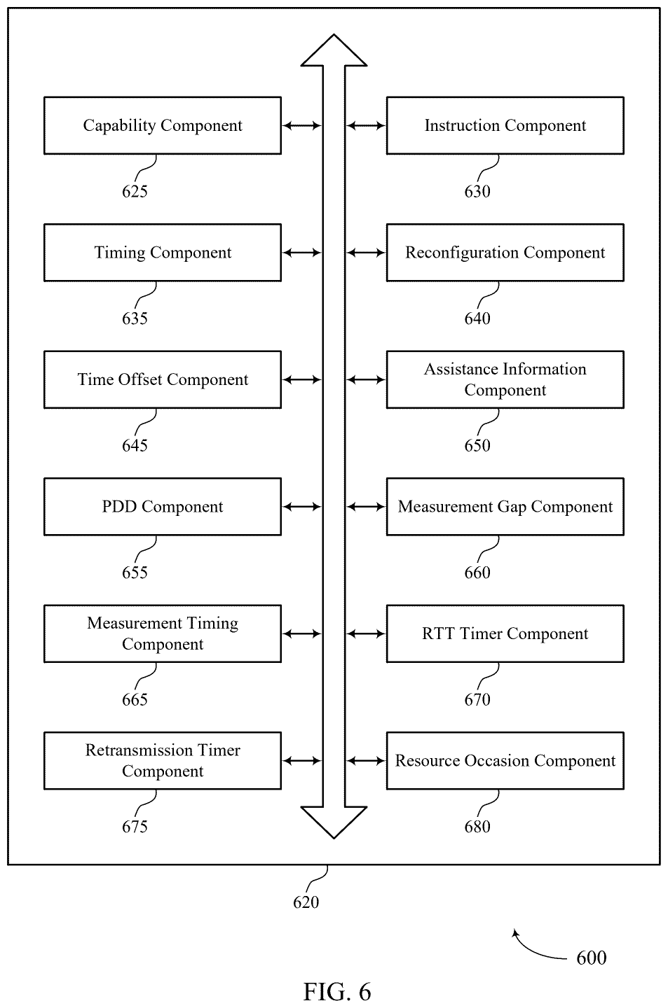

FIG. 6 shows a block diagram 600 of a communications manager 620 that supports timing adjustment for soft satellite switch with resynchronization in accordance with one or more aspects of the present disclosure. The communications manager 620 may be an example of aspects of a communications manager 420, a communications manager 520, or both, as described herein. The communications manager 620, or various components thereof, may be an example of means for performing various aspects of timing adjustment for soft satellite switch with resynchronization as described herein. For example, the communications manager 620 may include a capability component 625, an instruction component 630, a timing component 635, a reconfiguration component 640, a time offset component 645, an assistance information component 650, a PDD component 655, a measurement gap component 660, a measurement timing component 665, an RTT timer component 670, a retransmission timer component 675, a resource occasion component 680, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The capability component 625 is capable of, configured to, or operable to support a means for transmitting a first message indicating a capability of the UE to autonomously adjust a synchronization timing in accordance with a resynchronization operation. The instruction component 630 is capable of, configured to, or operable to support a means for receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

In some examples, the timing component 635 is capable of, configured to, or operable to support a means for adjusting, in response to switching from communications with the first network entity to communications with the second network entity, the synchronization timing in accordance with the resynchronization operation prior to a reception of a reconfiguration message. In some examples, the reconfiguration component 640 is capable of, configured to, or operable to support a means for receiving the reconfiguration message indicating a configuration for communicating with the second network entity in accordance with the resynchronization operation.

In some examples, the time offset component 645 is capable of, configured to, or operable to support a means for receiving a third message indicating the time offset associated with the resynchronization operation.

In some examples, the time offset component 645 is capable of, configured to, or operable to support a means for receiving a fourth message indicating whether the time offset includes a negative value or a positive value.

In some examples, the time offset component 645 is capable of, configured to, or operable to support a means for receiving a fifth message indicating a range that includes both positive values and negative values, where the time offset includes a value within the range.

In some examples, the assistance information component 650 is capable of, configured to, or operable to support a means for receiving, via a measurement object or a system information block, assistance information indicating a switch time associated with the resynchronization operation, a synchronization signal block offset time associated with the resynchronization operation, an identifier associated with the second network entity, or any combination thereof.

In some examples, the PDD component 655 is capable of, configured to, or operable to support a means for receiving a configuration for reporting a PDD between a plurality of multiple network entities. In some examples, the PDD component 655 is capable of, configured to, or operable to support a means for transmitting a first PDD between the first network entity and the second network entity, where the resynchronization operation is based at least in part on the first PDD.

In some examples, to support receiving the configuration for reporting the PDD, the PDD component 655 is capable of, configured to, or operable to support a means for receiving an indication of a threshold associated with a trigger event for reporting the PDD.

In some examples, the measurement gap component 660 is capable of, configured to, or operable to support a means for modifying, as part of the resynchronization operation and using the time offset, a measurement gap associated with the synchronization timing. In some examples, the measurement timing component 665 is capable of, configured to, or operable to support a means for modifying, as part of the resynchronization operation and using the time offset, a measurement timing configuration offset associated with the synchronization timing.

In some examples, the RTT timer component 670 is capable of, configured to, or operable to support a means for modifying, as part of the resynchronization operation and using the time offset, an expiry of a round trip time timer associated with the synchronization timing.

In some examples, the retransmission timer component 675 is capable of, configured to, or operable to support a means for modifying, as part of the resynchronization operation and using the time offset, an initialization of a retransmission timer associated with the synchronization timing.

In some examples, the resource occasion component 680 is capable of, configured to, or operable to support a means for modifying, as part of the resynchronization operation and using the time offset, a set of resource occasions associated with the synchronization timing.

In some examples, the time offset includes a synchronization signal block time offset.

In some examples, the first network entity and the second network entity include non-terrestrial network entities.

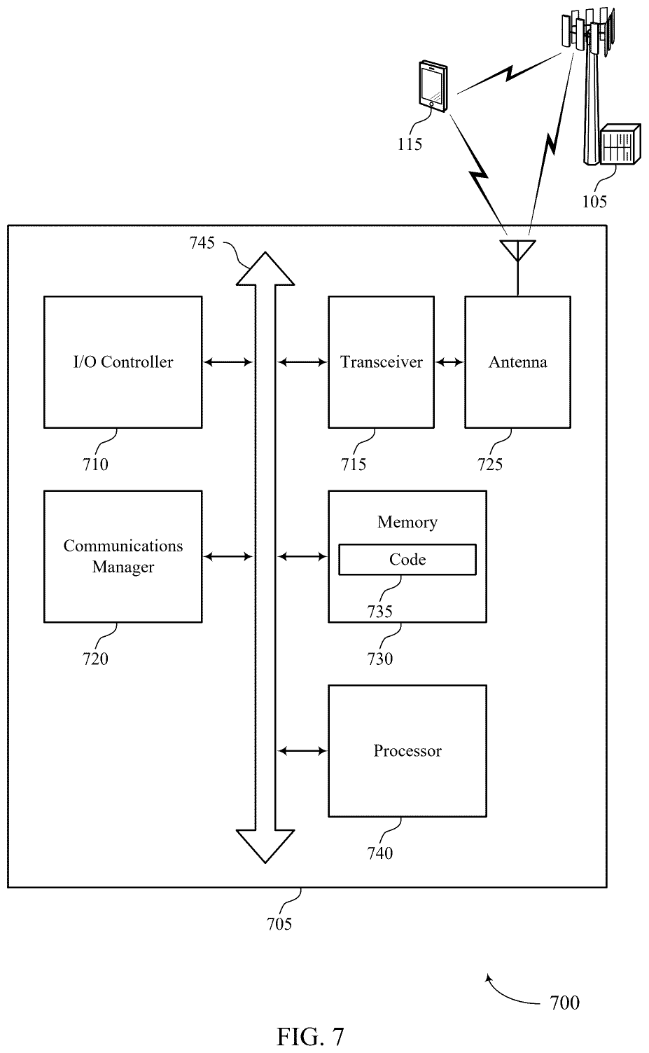

FIG. 7 shows a diagram of a system 700 including a device 705 that supports timing adjustment for soft satellite switch with resynchronization in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting timing adjustment for soft satellite switch with resynchronization). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for transmitting a first message indicating a capability of the UE to autonomously adjust a synchronization timing in accordance with a resynchronization operation. The communications manager 720 is capable of, configured to, or operable to support a means for receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

By including or configuring the communications manager 720 in accordance with examples as described herein, the device 705 may support techniques for timing adjustment for soft satellite switch with resynchronization, which may result in improved communication reliability, reduced latency, improved user experience related to reduced processing, reduced power consumption, more efficient utilization of communication resources, improved coordination between devices, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of timing adjustment for soft satellite switch with resynchronization as described herein, or the at least one processor 740 and the at least one memory 730 may be otherwise configured to, individually or collectively, perform or support such operations.

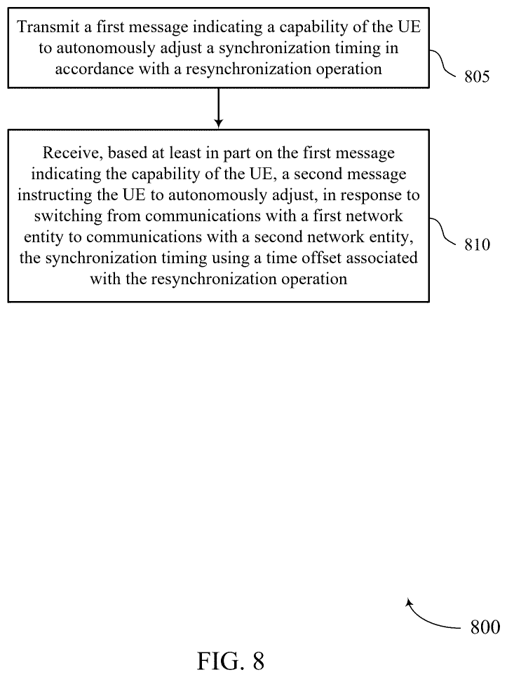

FIG. 8 shows a flowchart illustrating a method 800 that supports timing adjustment for soft satellite switch with resynchronization in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting a first message indicating a capability of the UE to autonomously adjust a synchronization timing in accordance with a resynchronization operation. The operations of 805 may be performed in accordance with examples as disclosed herein. In some examples, aspects of the operations of 805 may be performed by a capability component 625 as described with reference to FIG. 6.

At 810, the method may include receiving, based at least in part on the first message indicating the capability of the UE, a second message instructing the UE to autonomously adjust, in response to switching from communications with a first network entity to communications with a second network entity, the synchronization timing using a time offset associated with the resynchronization operation. The operations of 810 may be performed in accordance with examples as disclosed herein. In some examples, aspects of the operations of 810 may be performed by an instruction component 630 as described with reference to FIG. 6.

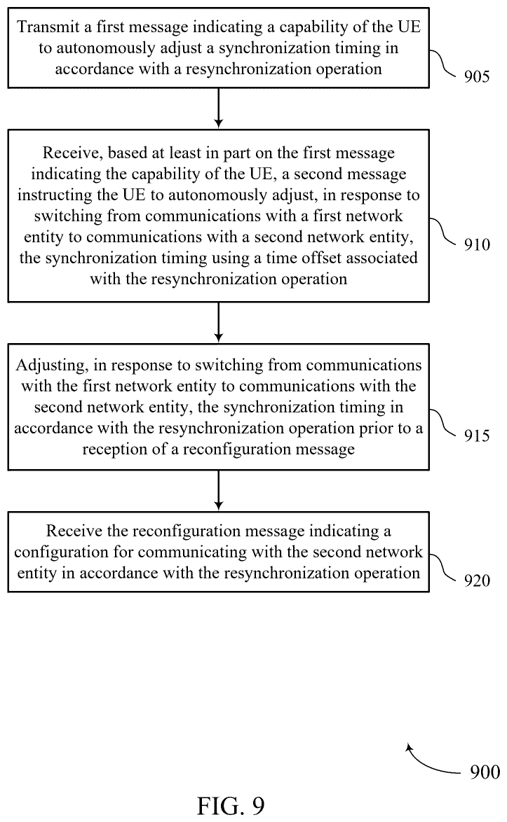

FIG. 9 shows a flowchart illustrating a method 900 that supports timing adjustment for soft satellite switch with resynchronization in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include transmitting a first message indicating a capability of the UE to autonomously adjust a synchronization timing in accordance with a resynchronization operation. The operations of 905 may be performed in accordance with examples as disclosed herein. In some examples, aspects of the operations of 905 may be performed by a capability component 625 as described with reference to FIG. 6.

At 910, the method may include receiving, based at least in part on the first message indicating the capability of the UE, a second message instructing the UE to autonomously adjust, in response to switching from communications with a first network entity to communications with a second network entity, the synchronization timing using a time offset associated with the resynchronization operation. The operations of 910 may be performed in accordance with examples as disclosed herein. In some examples, aspects of the operations of 910 may be performed by an instruction component 630 as described with reference to FIG. 6.

At 915, the method may include adjusting, in response to switching from communications with the first network entity to communications with the second network entity, the synchronization timing in accordance with the resynchronization operation prior to a reception of a reconfiguration message. The operations of 915 may be performed in accordance with examples as disclosed herein. In some examples, aspects of the operations of 915 may be performed by a timing component 635 as described with reference to FIG. 6.

At 920, the method may include receiving the reconfiguration message indicating a configuration for communicating with the second network entity in accordance with the resynchronization operation. The operations of 920 may be performed in accordance with examples as disclosed herein. In some examples, aspects of the operations of 920 may be performed by a reconfiguration component 640 as described with reference to FIG. 6.

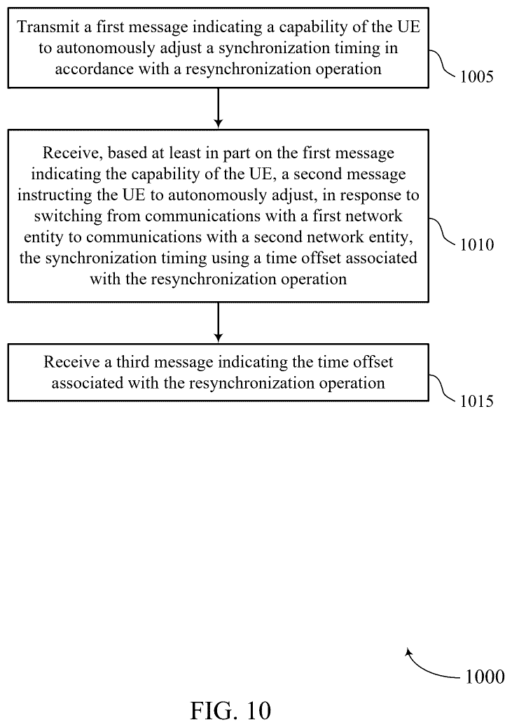

FIG. 10 shows a flowchart illustrating a method 1000 that supports timing adjustment for soft satellite switch with resynchronization in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include transmitting a first message indicating a capability of the UE to autonomously adjust a synchronization timing in accordance with a resynchronization operation. The operations of 1005 may be performed in accordance with examples as disclosed herein. In some examples, aspects of the operations of 1005 may be performed by a capability component 625 as described with reference to FIG. 6.

At 1010, the method may include receiving, based at least in part on the first message indicating the capability of the UE, a second message instructing the UE to autonomously adjust, in response to switching from communications with a first network entity to communications with a second network entity, the synchronization timing using a time offset associated with the resynchronization operation. The operations of 1010 may be performed in accordance with examples as disclosed herein. In some examples, aspects of the operations of 1010 may be performed by an instruction component 630 as described with reference to FIG. 6.

At 1015, the method may include receiving a third message indicating the time offset associated with the resynchronization operation. The operations of 1015 may be performed in accordance with examples as disclosed herein. In some examples, aspects of the operations of 1015 may be performed by a time offset component 645 as described with reference to FIG. 6.

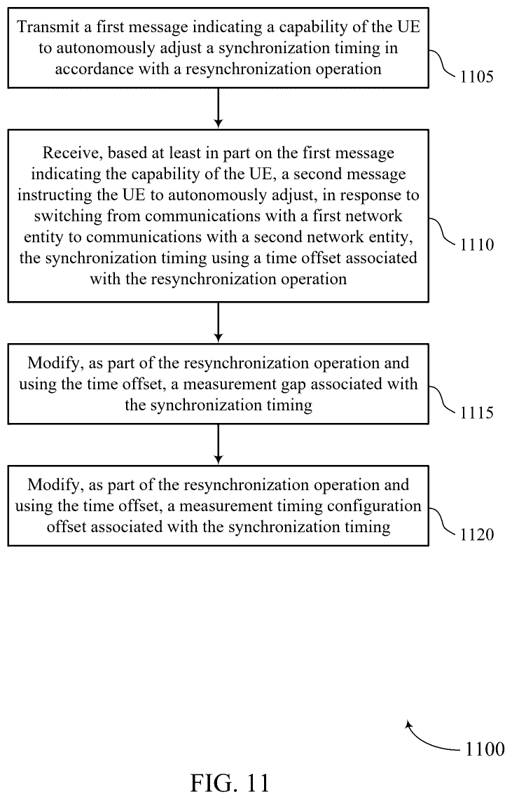

FIG. 11 shows a flowchart illustrating a method 1100 that supports timing adjustment for soft satellite switch with resynchronization in accordance with one or more aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include transmitting a first message indicating a capability of the UE to autonomously adjust a synchronization timing in accordance with a resynchronization operation. The operations of 1105 may be performed in accordance with examples as disclosed herein. In some examples, aspects of the operations of 1105 may be performed by a capability component 625 as described with reference to FIG. 6.

At 1110, the method may include receiving, based at least in part on the first message indicating the capability of the UE, a second message instructing the UE to autonomously adjust, in response to switching from communications with a first network entity to communications with a second network entity, the synchronization timing using a time offset associated with the resynchronization operation. The operations of 1110 may be performed in accordance with examples as disclosed herein. In some examples, aspects of the operations of 1110 may be performed by an instruction component 630 as described with reference to FIG. 6.

At 1115, the method may include modifying, as part of the resynchronization operation and using the time offset, a measurement gap associated with the synchronization timing. The operations of 1115 may be performed in accordance with examples as disclosed herein. In some examples, aspects of the operations of 1115 may be performed by a measurement gap component 660 as described with reference to FIG. 6.

At 1120, the method may include modifying, as part of the resynchronization operation and using the time offset, a measurement timing configuration offset associated with the synchronization timing. The operations of 1120 may be performed in accordance with examples as disclosed herein. In some examples, aspects of the operations of 1120 may be performed by a measurement timing component 665 as described with reference to FIG. 6.

The following provides an overview of aspects of the present disclosure:

Aspect 1: A method for wireless communication at a UE, comprising: transmitting a first message indicating a capability of the UE to autonomously adjust a synchronization timing in accordance with a resynchronization operation; and receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

Aspect 2: The method of aspect 1, further comprising: adjusting, in response to switching from communications with the first network entity to communications with the second network entity, the synchronization timing in accordance with the resynchronization operation prior to a reception of a reconfiguration message; and receiving the reconfiguration message indicating a configuration for communicating with the second network entity in accordance with the resynchronization operation.

Aspect 3: The method of any of aspects 1 through 2, further comprising: receiving a third message indicating the time offset associated with the resynchronization operation.

Aspect 4: The method of any of aspects 1 through 3, further comprising: receiving a fourth message indicating whether the time offset comprises a negative value or a positive value.

Aspect 5: The method of any of aspects 1 through 4, further comprising: receiving a fifth message indicating a range that includes both positive values and negative values, wherein the time offset comprises a value within the range.

Aspect 6: The method of any of aspects 1 through 5, further comprising: receiving, via a measurement object or a system information block, assistance information indicating a switch time associated with the resynchronization operation, an SSB offset time associated with the resynchronization operation, an identifier associated with the second network entity, or any combination thereof.

Aspect 7: The method of any of aspects 1 through 6, further comprising: receiving a configuration for reporting a PDD between a plurality of network entities; and transmitting a first PDD between the first network entity and the second network entity, wherein the resynchronization operation is based at least in part on the first PDD.

Aspect 8: The method of aspect 7, wherein receiving the configuration for reporting the PDD comprises: receiving an indication of a threshold associated with a trigger event for reporting the PDD.

Aspect 9: The method of any of aspects 1 through 8, further comprising: modifying, as part of the resynchronization operation and using the time offset, a measurement gap associated with the synchronization timing; and modifying, as part of the resynchronization operation and using the time offset, a measurement timing configuration offset associated with the synchronization timing.

Aspect 10: The method of any of aspects 1 through 9, further comprising: modifying, as part of the resynchronization operation and using the time offset, an expiry of a RTT timer associated with the synchronization timing.

Aspect 11: The method of any of aspects 1 through 10, further comprising: modifying, as part of the resynchronization operation and using the time offset, an initialization of a retransmission timer associated with the synchronization timing.

Aspect 12: The method of any of aspects 1 through 11, further comprising: modifying, as part of the resynchronization operation and using the time offset, a set of resource occasions associated with the synchronization timing.

Aspect 13: The method of any of aspects 1 through 12, wherein the time offset comprises an SSB time offset.

Aspect 14: The method of any of aspects 1 through 13, wherein the first network entity and the second network entity comprise non-terrestrial network entities.

Aspect 15: A UE for wireless communication, comprising one or more memories storing processor-executable code, and one or more processors coupled with the one or more memories and individually or collectively operable to execute the code to cause the UE to perform a method of any of aspects 1 through 14.

Aspect 16: A UE for wireless communication, comprising at least one means for performing a method of any of aspects 1 through 14.

Aspect 17: A non-transitory computer-readable medium storing code for wireless communication, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first message indicating a capability of the UE to autonomously adjust a synchronization timing in accordance with a resynchronization operation; and
receive, based at least in part on the first message indicating the capability of the UE, a second message instructing the UE to autonomously adjust, in response to switching from communications with a first network entity to communications with a second network entity, the synchronization timing using a time offset associated with the resynchronization operation.

2. The UE of claim 1, wherein the one or more processors are individually or collectively further operable to execute the code to cause the UE to:
adjusting, in response to a switch from communications with the first network entity to communications with the second network entity, the synchronization timing in accordance with the resynchronization operation prior to a reception of a reconfiguration message; and
receive the reconfiguration message indicating a configuration for communicating with the second network entity in accordance with the resynchronization operation.

3. The UE of claim 1, wherein the one or more processors are individually or collectively further operable to execute the code to cause the UE to:
receive a third message indicating the time offset associated with the resynchronization operation.

4. The UE of claim 1, wherein the one or more processors are individually or collectively further operable to execute the code to cause the UE to:
receive a fourth message indicating whether the time offset comprises a negative value or a positive value.

5. The UE of claim 1, wherein the one or more processors are individually or collectively further operable to execute the code to cause the UE to:
receive a fifth message indicating a range that includes both positive values and negative values, wherein the time offset comprises a value within the range.

6. The UE of claim 1, wherein the one or more processors are individually or collectively further operable to execute the code to cause the UE to:
receive, via a measurement object or a system information block, assistance information indicating a switch time associated with the resynchronization operation, a synchronization signal block offset time associated with the resynchronization operation, an identifier associated with the second network entity, or any combination thereof.

7. The UE of claim 1, wherein the one or more processors are individually or collectively further operable to execute the code to cause the UE to:
receive a configuration for reporting a propagation delay difference between a plurality of network entities; and
transmit a first propagation delay difference between the first network entity and the second network entity, wherein the resynchronization operation is based at least in part on the first propagation delay difference.

8. The UE of claim 7, wherein, to receive the configuration for reporting the propagation delay difference, the one or more processors are individually or collectively operable to execute the code to cause the UE to:
receive an indication of a threshold associated with a trigger event for reporting the propagation delay difference.

9. The UE of claim 1, wherein the one or more processors are individually or collectively further operable to execute the code to cause the UE to:
modify, as part of the resynchronization operation and using the time offset, a measurement gap associated with the synchronization timing; and
modify, as part of the resynchronization operation and using the time offset, a measurement timing configuration offset associated with the synchronization timing.

10. The UE of claim 1, wherein the one or more processors are individually or collectively further operable to execute the code to cause the UE to:
modify, as part of the resynchronization operation and using the time offset, an expiry of a round trip time timer associated with the synchronization timing.

11. The UE of claim 1, wherein the one or more processors are individually or collectively further operable to execute the code to cause the UE to:
modify, as part of the resynchronization operation and using the time offset, an initialization of a retransmission timer associated with the synchronization timing.

12. The UE of claim 1, wherein the one or more processors are individually or collectively further operable to execute the code to cause the UE to:
modify, as part of the resynchronization operation and using the time offset, a set of resource occasions associated with the synchronization timing.

13. The UE of claim 1, wherein the time offset comprises a synchronization signal block time offset.

14. The UE of claim 1, wherein:
the first network entity and the second network entity comprise non-terrestrial network entities.

15. A method for wireless communication at a user equipment (UE), comprising:
transmitting a first message indicating a capability of the UE to autonomously adjust a synchronization timing in accordance with a resynchronization operation; and
receiving, based at least in part on the first message indicating the capability of the UE, a second message instructing the UE to autonomously adjust, in response to switching from communications with a first network entity to communications with a second network entity, the synchronization timing using a time offset associated with the resynchronization operation.

16. The method of claim 15, further comprising:
adjusting, in response to switching from communications with the first network entity to communications with the second network entity, the synchronization timing in accordance with the resynchronization operation prior to a reception of a reconfiguration message; and
receiving the reconfiguration message indicating a configuration for communicating with the second network entity in accordance with the resynchronization operation.

17. The method of claim 15, further comprising:
receiving a third message indicating the time offset associated with the resynchronization operation.

18. A non-transitory computer-readable medium storing code for wireless communication at a user equipment (UE), the code comprising instructions executable by one or more processors to:
transmit a first message indicating a capability of the UE to autonomously adjust a synchronization timing in accordance with a resynchronization operation; and
receive, based at least in part on the first message indicating the capability of the UE, a second message instructing the UE to autonomously adjust, in response to switching from communications with a first network entity to communications with a second network entity, the synchronization timing using a time offset associated with the resynchronization operation.

19. The non-transitory computer-readable medium of claim 18, wherein the instructions are further executable by the one or more processors to:
adjusting, in response to a switch from communications with the first network entity to communications with the second network entity, the synchronization timing in accordance with the resynchronization operation prior to a reception of a reconfiguration message; and
receive the reconfiguration message indicating a configuration for communicating with the second network entity in accordance with the resynchronization operation.

20. The non-transitory computer-readable medium of claim 18, wherein the instructions are further executable by the one or more processors to:
receive a third message indicating the time offset associated with the resynchronization operation.
